(19) United States
(12) Patent Application Publication
(10) Pub. No.: US 2024/0186798 A1
(43) Pub. Date: Jun. 6, 2024

(54) CONTROL TERMINAL IN POWER GENERATION SYSTEM, CONTROL PROGRAM FOR POWER GENERATION SYSTEM, AND METHOD FOR MANUFACTURING POWER GENERATION SYSTEM

(71) Applicant: Laplace System Co., Ltd., Kyoto (JP)

(72) Inventors: Masayuki HORII, Kyoto (JP); Kozue NISHIMURA, Kyoto (JP)

(21) Appl. No.: 18/553,467

(22) PCT Filed: Mar. 29, 2022
(86) PCT No.: PCT/JP2022/015653

§ 371 Date: Sep. 29, 2023

(30) Foreign Application Priority Data
Mar. 31, 2021 (JP) 2021-059512

(51) Int. Cl. H02J 3/46; H02J 13/00

(52) U.S. Cl. CPC H02J 3/46; H02J 13/00002

(57) ABSTRACT

A power generation system including multiple power generation controllers responds to a changeable power consumption level and efficiently supplies power from power generators to loads. A program is used for a control terminal to control output power of a power generation system. The power generation system includes multiple power generators and multiple power generation controllers to control output power generation levels of the respective power generators. The program is executable to perform operations including obtaining a power consumption level of a load, obtaining a total power generation level of the power generation system, determining whether to tighten or loosen control by calculating a total allowable power generation level of the power generation system based on the power consumption level and the total power generation level, and calculating, based on a result of the determining, an output command value at a current time (t=t1) for each power generation controller.

### FIELD

The present invention relates to a control terminal in a power generation system, a control program for the power generation system, and a method for manufacturing the power generation system.

### BACKGROUND

A known power generation control system calculates the output power levels of power generation controllers (power conditioners) based on the power consumption level of loads to avoid backfeeding to utility power lines and allow more efficient power generation (e.g., Patent Literature 1). Known power generation systems include centralized systems including a single high-capacity power generation controller connected to multiple power generators, and distributed systems including multiple low-capacity power generation controllers. In a distributed power generation system, multiple power generation controllers have output power generation levels controlled by a single controller (refer to, for example, Patent Literature 2, FIG. 5). The distributed power generation system, which includes multiple power generation controllers to be controlled, typically provides all the power generation controllers with the same output command value for power generation (e.g., Patent Literature 2).

### CITATION LIST

### Patent Literature

Patent Literature 1: Japanese Unexamined Patent Application Publication No. 2019-161777
Patent Literature 2: Japanese Unexamined Patent Application Publication No. 2017-093127

### BRIEF SUMMARY

### Technical Problem

In the distributed power generation system, all the power generation controllers receiving the same output command value may not be controlled in the same manner. Power generation controllers with different specifications (e.g., capacities, performance, or manufacturers) can have different response speeds. Power generation controllers with the same specifications can also have individual differences due to, for example, different cumulative operation years when some power generators and power generation controllers are added later. Further, power generation facilities connected to such power generation controllers can also have individual differences and have different power generation characteristics depending on their installation locations or local weather conditions. Thus, the control method for the centralized system, with which each power generation controller uses the same output command value, may not be appropriate for the distributed power generation system.

One or more aspects of the present invention are technically directed to a control terminal in a distributed power generation system including multiple power generators and multiple power generation controllers that can avoid backfeeding and allow efficient power supply by calculating an output command value for power generation appropriate for each power generation controller promptly in response to a temporal change in the power consumption level, and are also directed to a control program for the power generation system and a method for manufacturing the power generation system.

### Solution to Problem

A control program for a power generation system according to an aspect of the present invention is a program for a control terminal (6) to control output power of a power generation system (100). The power generation system (100) includes a plurality of power generators (1) and a plurality of power generation controllers (2) to control output power generation levels of the respective plurality of power generators (1). The program is executable to perform operations including obtaining (Sa1, Sb1) a power consumption level of a load (5), obtaining (Sa2, Sb2) a total allowable power generation level of the power generation system (100), determining (Sa3, Sb3-1) whether to tighten or loosen control by calculating the total allowable power generation level of the power generation system based on the power consumption level and the total power generation level, and calculating (Sa3-1-3, Sa3-2-3, Sb3-1-3, Sb3-2-3), based on a result of the determining, an output command value at a current time (t=t1) for each of the plurality of power generation controllers (2).

In the above structure, the determining (Sa3) may include determining whether the total allowable power generation level decreases, and when determining that the total allowable power generation level decreases, the determining (Sa3) may at least include calculating (Sa3-1-1) a decrease target value, selecting (Sa3-1-2), from the plurality of power generation controllers, a power generation controller having a maximum actual power generation level, reflecting (Sa3-1-3) the decrease target value with respect to the output command value for the selected power generation controller, and determining (Sa3-1-4) whether the decrease target value is achieved.

In the above structure, the determining (Sa3-1-4) may include, when the decrease target value is unachieved, selecting (Sa3-1-5), from the plurality of power generation controllers, a power generation controller previously unselected and having a maximum actual power generation level, and performing the reflecting (Sa3-1-3) again to reflect an unachieved value of the decrease target value for the selected power generation controller.

In the above structure, the determining (Sa3) may include determining whether the total allowable power generation level decreases, and when determining that the total allowable power generation level does not decrease, the determining (Sa3) may at least include calculating (Sa3-2-1) an increase target value, selecting (Sa3-2-2), from the plurality of power generation controllers, a power generation controller having a minimum actual power generation level, reflecting (Sa3-2-3) the increase target value with respect to the output command value for the selected power generation controller, and determining (Sa3-2-4) whether the increase target value is achieved.

In the above structure, the determining (Sa3-2-4) may include, when the increase target value is unachieved, selecting (Sa3-2-5), from the plurality of power generation controllers, a power generation controller previously unselected and having a minimum actual power generation level, and performing the reflecting (Sa3-2-3) again to reflect an unachieved value of the increase target value for the selected power generation controller.

In the above structure, the determining (Sb3-1) may include determining whether the total power generation level at the current time (t=t1) is higher than the total allowable power generation level at the current time (t=t1), and when determining that the total power generation level is higher than the total allowable power generation level, the determining (Sb3-1) may at least include calculating (Sb3-1-1) a decrease target value, selecting (Sb3-1-2), from the plurality of power generation controllers, a power generation controller having a maximum actual power generation level, reflecting (Sb3-1-3) the decrease target value with respect to an actual power generation level for the selected power generation controller, and determining (Sb3-1-4) whether the decrease target value is achieved.

In the above structure, the determining (Sb3-1-4) may include, when the decrease target value is unachieved, selecting (Sb3-1-5), from the plurality of power generation controllers, a power generation controller previously unselected and having a maximum actual power generation level, and performing the reflecting (Sa3-1-3) again to reflect an unachieved value of the decrease target value for the selected power generation controller.

In the above structure, the determining (Sb3-1) may include determining whether the total power generation level at the current time (t=t1) is higher than the total allowable power generation level at the current time (t=t1), and when determining that the total power generation level is not higher than the total allowable power generation level, the determining (Sb3-1) may at least include determining (Sb3-2) whether all the plurality of power generation controllers (2) are operating at values lower than or equal to the output command values, and when determining that all the plurality of power generation controllers (2) are operating at values lower than or equal to the output command values, the determining (Sb3-1) may include determining (Sb3-3) whether a power generation level at the current time (t=t1) has increased from a power generation level at a time (t=t0) in a preceding cycle, and when determining that all the plurality of power generation controllers (2) are operating at values lower than or equal to the output command values and the power generation level at the current time (t=t1) has not increased from the power generation level at the time (t=t0) in the preceding cycle, the determining (Sb3-1) may include maintaining an output level at the time (t=t0) in the preceding cycle and returning to the obtaining (Sb1) the power consumption level.

In the above structure, the determining (Sb3-1) may include determining whether the total power generation level at the current time (t=t1) is higher than the total allowable power generation level at the current time (t=t1), and when determining that the total power generation level is not higher than the total allowable power generation level, the determining (Sb3-1) may at least include determining (Sb3-2) whether all the plurality of power generation controllers (2) are operating at values lower than or equal to the output command values, and when determining that all the plurality of power generation controllers (2) are operating at values lower than or equal to the output command values, the determining (Sb3-1) may include determining (Sb3-3) whether a power generation level at the current time (t=t1) has increased from a power generation level at a time (t=t0) in a preceding cycle, and when determining that not all the plurality of power generation controllers (2) are operating at values lower than or equal to the output command values or when determining that the power generation level at the current time (t=t1) has increased in the determining (Sb3-3), the determining (Sb3-1) may include calculating (Sb3-2-1) an increase target value, selecting (Sb3-2-2), from the plurality of power generation controllers, a power generation controller having a minimum output command value, reflecting (Sb3-2-3) the increase target value with respect to an actual power generation level for the selected power generation controller, and determining (Sa3-2-4) whether the increase target value is achieved.

In the above structure, the determining (Sb3-2-4) may include, when the increase target value is unachieved, selecting (Sb3-2-5), from the plurality of power generation controllers, a power generation controller previously unselected and having a minimum output command value, and performing the reflecting (Sb3-2-3) again to reflect an unachieved value of the increase target value for the selected power generation controller.

A control terminal according to an aspect of the present invention is operable using any of the above programs.

A method for manufacturing a power generation system according to an aspect of the present invention includes connecting the above control terminal to a power generation controller configured to control an output based on an output command value.

### Advantageous Effects

The technique according to the above aspects of the present invention can set an output command value for each power generation controller, and can thus calculate the output command value for power generation appropriate for each power generation controller promptly in response to a temporal change in the power consumption level. This can avoid backfeeding and allows fine control, thus further increasing the power generation level in the entire power generation system. The technique also allows control of the operating state for each power generation controller. This can average the service lives of the power generation controllers, allows particularly high-efficiency power generators to be mainly used, allows high-response power generation controllers to be actively used when the power consumption level varies greatly, and allows power generation controllers with different characteristics and specifications to be used in combination.

### BRIEF DESCRIPTION OF DRAWINGS

FIG. 1 is a schematic diagram of a power generation system 100, showing its main components.

FIG. 2 is a block diagram of a control terminal 6, showing its main functional components.

FIG. 3 is a main flowchart of a method for controlling power generation according to a second embodiment with the power generation system 100 including the control terminal 6 according to a first embodiment.

FIG. 4 is a conceptual diagram showing the relationship between the output command value and the actual power generation level for each power generation controller for tightening the control (case a, or C1-1).

FIG. 5 is a conceptual diagram showing the relationship between the output command value and the actual power generation level for each power generation controller for tightening the control (case b, or C1-2).

FIG. 6 is a conceptual diagram showing the relationship between the output command value and the actual power generation level for each power generation controller for loosening the control (case c, or C1-3).

FIG. 7 is a main flowchart of a method for controlling power generation according to a third embodiment with the power generation system 100 including the control terminal 6 according to the first embodiment.

FIG. 8 is a conceptual diagram showing the relationship between the output command value and the actual power generation level for each power generation controller for tightening the control (case d, or C2-1).

FIG. 9 is a conceptual diagram showing the relationship between the output command value and the actual power generation level for each power generation controller for tightening the control (case e, or C2-2).

FIG. 10 is a conceptual diagram showing the relationship between the output command value and the actual power generation level for each power generation controller for loosening the control (case f, or C2-3).

FIG. 11 is a conceptual diagram showing the relationship between the output command value and the actual power generation level for each power generation controller for loosening the control (case f, or C2-3).

FIG. 12 is a table showing combinations of control patterns to select a power generation controller and to calculate the output command value for tightening and loosening the control in the third embodiment.

FIGS. 13A to 13C are tables each showing changes in the grid power level, the power generation level, the output command value, and the calculated value of power consumption that is the sum of the grid power level and the power generation level based on conditions 1 to 3.

FIG. 14 is a conceptual diagram showing the relationship between the output command value and the actual power generation level for each power generation controller for loosening the control without using conditions 1 to 3.

FIG. 15 is a conceptual diagram showing the relationship between the output command value and the actual power generation level for each power generation controller for loosening the control based on conditions 1 to 3.

### DETAILED DESCRIPTION

Embodiments of the present invention will now be described with reference to the drawings. The embodiments described below are not limitative in the interpretation of the scope of the present invention. Like reference numerals denote the same or like components in the embodiments, and such components may not be described repeatedly.

The power values described below are mere examples for ease of understanding, and are not limitative in their interpretation.

### DEFINITION OF TERMS

The terms in one or more aspects of the present invention are defined below.

A power generation system refers to a distributed power generation system including multiple power generation controllers for grid connection.

A power generation controller refers to a power conditioner that controls the output based on an output command value.

An actual power generation level refers to the output power level of each power generation controller.

A total power generation level refers to the power generation level of the entire power generation system that is the sum of the output power levels (actual power generation levels) of the power generation controllers.

A total allowable power generation level refers to the sum of power generation levels allowed in the entire system to avoid backfeeding and calculated based on the measurement value of power consumption.

A control terminal refers to a device that calculates the total allowable power generation level at the current time t (t=t1) based on the power consumption level of loads at the current time t (t=t1), calculates a control command value for transmission to each power generation controller, and transmits the control command value at an appropriate timing.

An output command value refers to the upper limit of an allowable power generation level for each power generation controller (expressed as a percentage of an output value to the rated output or expressed directly as an output value).

Tightening control refers to recalculating the output command value for power generation controllers to decrease the total allowable power generation level to be lower than the total allowable power generation level at time t in the preceding cycle (t=t0).

Loosening control refers to recalculating the output command value for power generation controllers to increase the total allowable power generation level to be higher than the total allowable power generation level at time t in the preceding cycle (t=t0).

Maintaining control refers to cause the total allowable power generation level to remain unchanged from the total power generation level at time t in the preceding cycle (t=t0), without recalculating the output command value.

### System Configuration in First Embodiment

An example power generation system 100 including power generators 1 will now be described.

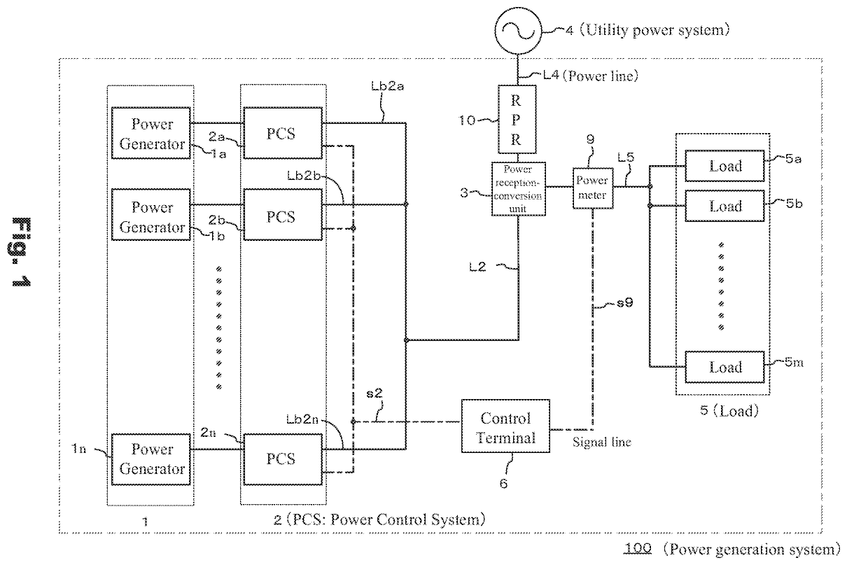

FIG. 1 is a schematic diagram of the power generation system 100, showing its main components. The power generators 1 may be any types of power generators usable in a power generation system for grid connection. The power generators may be, for example, solar cells and may have their power generation levels changeable under external conditions such as weather conditions.

The power generation system 100 includes multiple power generators 1 (1a, 1b, . . . , In) and multiple power generation controllers 2 (2a, 2b, . . . , 2n) that control the power generation levels of the respective power generators 1. The components may be indicated by reference numerals without the letters a, b, . . . , n. For example, the power generator 1 may refer to the power generator 1a, 1b, . . . , or 1n, as appropriate in the context.

For the power generators 1 being solar cells, each power generator 1 (e.g., the power generator 1a) includes a unit or an array of multiple solar panels. A single power generator and a single power generation controller 2 that controls the power generator form a single power generation unit.

The power generators 1 may not have the same power generation capacity. The power generation controllers 2 may not have the same control capability (capacity). For example, the power generators 1 or the power generation controllers 2 may differ in their installation conditions, manufacturer, conditions of use, or cumulative years of use. Further, the power generation controllers 2 typically have different outputs under, for example, different sunlight conditions, causing the power generators 1 to have different power generation levels. Thus, the output power levels of the power generation controllers 2 change with time differently depending on individual differences in the power generation capacities of the power generators 1, the ambient environmental conditions (e.g., the amount of sunlight or temperature), the installation locations, or the time.

The power generation controllers 2 may convert direct current (DC) power output from the power generators 1 to alternating current (AC) power. The power generation level of each power generator 1 connected to the corresponding power generation controller is individually controlled to be maximized within the range of the output command value being provided. For the power generators 1 being solar cells, for example, the power generation controllers perform output control to maximize the power levels within the output command values using any known algorithm such as maximum power point tracking (MPPT).

Multiple power lines Lb (Lb2a, Lb2b, . . . , Lb2n) and a power line L4 for a utility power system 4 from, for example, a power company, are both connected to loads 5 (5a, 5b, . . . , 5m, where m is the number of loads) through a power reception-conversion unit 3 and a power line L5.

A control terminal 6 obtains the power consumption level of the loads 5 from a power meter 9 through a signal line s9. The power meter may be installed in the utility power system 4. In this case, the power consumption level may be calculated based on the total power generation level of the power generation controllers and the level of power from the utility power system 4.

In normal operation, the measurement terminal (control terminal) 6 may sequentially obtain the output power levels of the power generation controllers through a signal line s2 and repeat the operation for intended control. Alternatively or additionally, the terminal may select (pick up) one or more (not all) specific power generation controllers and control the selected power generation controllers individually, as is the basic idea of one or more aspects of the present invention.

The control terminal 6 can calculate the output command value for transmission to each power generation controller, and transmit the output command value at an appropriate timing.

The power consumption level of the loads 5 may be measured directly by the power meter 9 installed on the power line L5. In some embodiments, the power consumption level of the loads 5 may be calculated based on the level of power from the utility power system 4 and the sum of the levels of output power from the power generation controllers 2 (a relevant issue in this case will be described later in a fourth embodiment). Although the system may include multiple loads 5, the power consumption level herein simply refers to the sum of the power consumption levels of the individual loads 5 (5a, 5b, . . . , 5m).

To accurately measure the changeable power consumption level, the power meter 9 is used to directly measure the total power consumption level in FIG. 1.

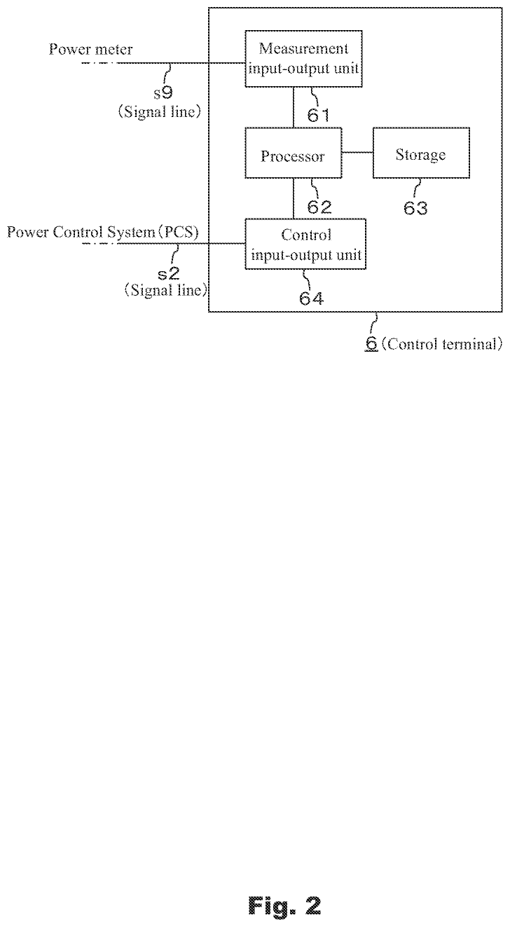

FIG. 2 is a block diagram of the control terminal 6, showing its main functional components. Although not shown, the control terminal 6 includes hardware components for implementing the functional blocks shown in FIG. 2, such as a micro processing unit (MPU), a clock, a memory, and a communication interface.

As shown in FIG. 2, the control terminal 6 includes a measurement input-output unit 61 that communicates with the power meter 9 connected to the signal line s9, a processor or a central processing unit (CPU) 62 that performs various arithmetic operations, a storage 63 that stores, for example, obtained power values, and a control input-output unit 64 that inputs and outputs signals used for control.

The control terminal 6 communicates with the power generation controllers 2 through the signal line s2, and communicates with the power meter 9 through the signal line s9.

The levels of power generated by the power generators 1 are output by the power generation controllers 2 as the levels of AC power for grid connection with the utility power system 4. The control terminal 6 obtains the output power levels of the power generation controllers through the signal line s2. The control terminal 6 can calculate the total power generation level that is the sum of the output power levels (actual power generation levels) of the power generation controllers 2 at each time.

To avoid backfeeding, the system may further include a reverse power relay (RPR) 10 installed on the power line L4. The RPR 10 can respond to unexpected failures or other abnormalities in, for example, a power generation controller.

To avoid backfeeding without the RPR 10 being disconnected, the loads 5 are to receive power at a level controlled not to exceed their power consumption level. More specifically, the power generation controllers are to have the total power generation level controlled to be lower than or equal to their total allowable power generation level that is the sum of the upper limits of their power generation levels defined by output command values.

The power consumption level of the loads 5 is a function of time. Thus, backfeeding is more likely to occur with, for example, a smaller difference between the total power generation level and the power consumption level. The control terminal 6 transmits output command values to the power generation controllers 2 to decrease the upper limits of power to be generated with the power generation controllers, thus tightening control of power generation. In contrast, backfeeding is less likely to occur with a larger difference between the total power generation level and the power consumption level. The control terminal 6 transmits output command values to the power generation controllers 2 to increase the upper limits of power to be generated with the power generation controllers, thus relaxing control of power generation.

As described below, the distributed power generation system according to an aspect of the present embodiment, which includes the multiple power generators 1 and the multiple power generation controllers 2, calculates and sets an optimal output command value individually for a specific power generation controller selected based on a predetermined algorithm, rather than setting the same output command value for all the power generation controllers. The system may theoretically include different types of power generators (e.g., wind power generators and solar power generators or other power generators).

The total allowable power generation level may be calculated with any known method. For example, the output command value may be calculated to cause the output power to have the value resulting from subtracting a certain margin from the power consumption level at time t in the preceding cycle (t=t0). In some embodiments, the output command value may be calculated as a function of the power consumption level. Any other method may be used to calculate the total allowable power generation level at the current time t (t=t1) based on the total power generation level at the current time t (t=t1) and the power consumption level of the loads at any time point.

The control terminal 6 calculates the output command value for each power generation controller 2 (2a, 2b, . . . , 2n) at the current time t (t=t1) based on the total allowable power generation level at the current time t (t=t1) calculated by the processor 62, and transmits the output command value to the corresponding power generation controller 2. The output command value is provided to each power generation controller 2 and indicates the upper limit of the allowable output power level of the power generation controller. The output command value becomes effective in the power generation controller 2 in the subsequent cycle or at any later timing, but may not refer to the actual power generation level. The timing at which the output command value becomes effective depends on, for example, the structure and the specifications of the power generation controller.

For a solar power generator, for example, the actual power generation level may be lower than the upper limit of the output power level specified by the output command value under certain weather conditions such as cloudy weather. More specifically, for example, the actual power generation level is often lower than 50% of the rated output when the output command value specifies 80% of the rated output. In this case, the grid connection system uses power from the grid to compensate for the power shortage.

Thus, the control terminal 6 may perform control to maximize the total power generation level based on the actual power generation level of each power generation controller 2.

In FIG. 2, the control terminal 6 stores a program in the storage 63 to perform control processing. The processor 62 executes the program stored in the storage 63 to calculate the output command value to be transmitted to each power generation controller 2.

The output command value may be defined as a ratio to the rated power level, or may directly refer to the upper limit of the power generation level. When the command value is defined as a ratio to the rated power level, the command value multiplied by the rated power level is determined to be the upper limit of the power generation level. In this case, the output command value is an abstract number of 0 to 1 inclusive (0 to 100% inclusive). In the example below, for simplicity of explanation, the output command value directly refers to the upper limit of the power generation level, such as 30 kW.

### First Control Method in Second Embodiment

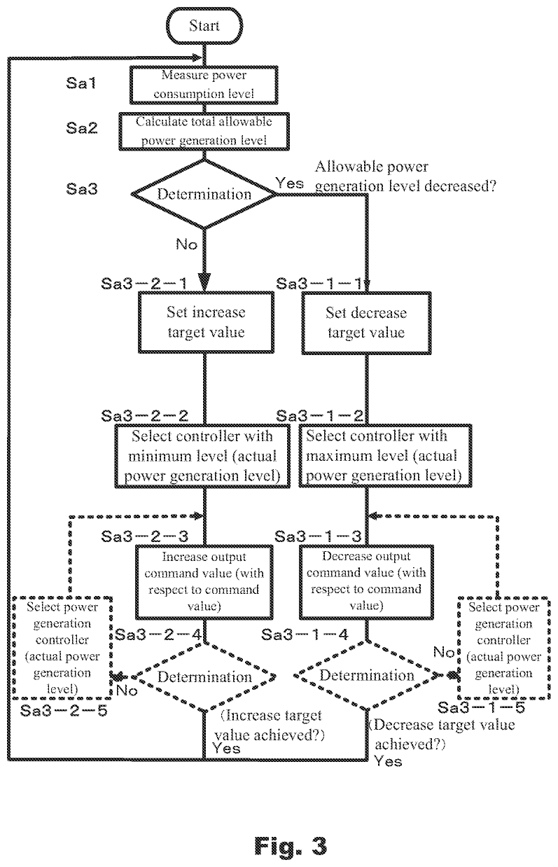

A method for controlling power generation will now be described with reference to FIGS. 3 to 6. FIG. 3 is a main flowchart of a method for controlling power generation according to a second embodiment with the power generation system 100 including the control terminal 6 according to the first embodiment.

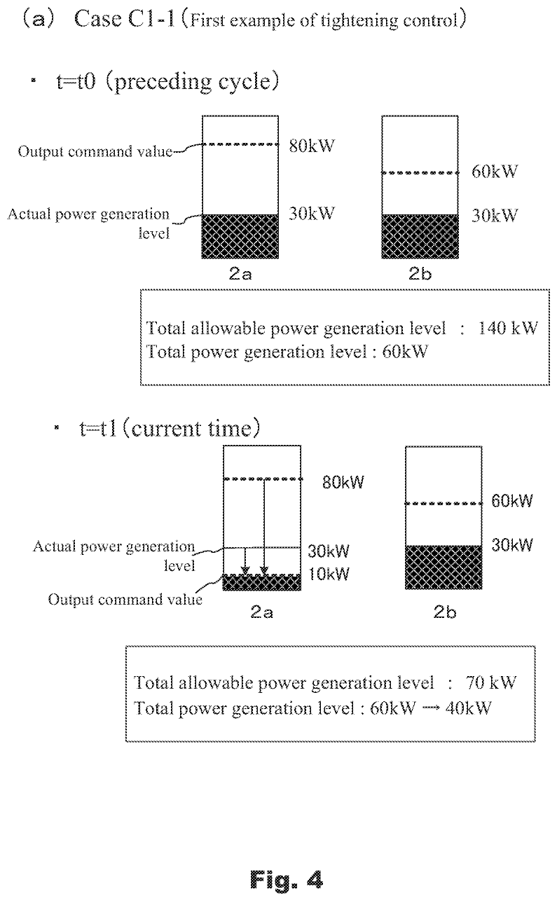

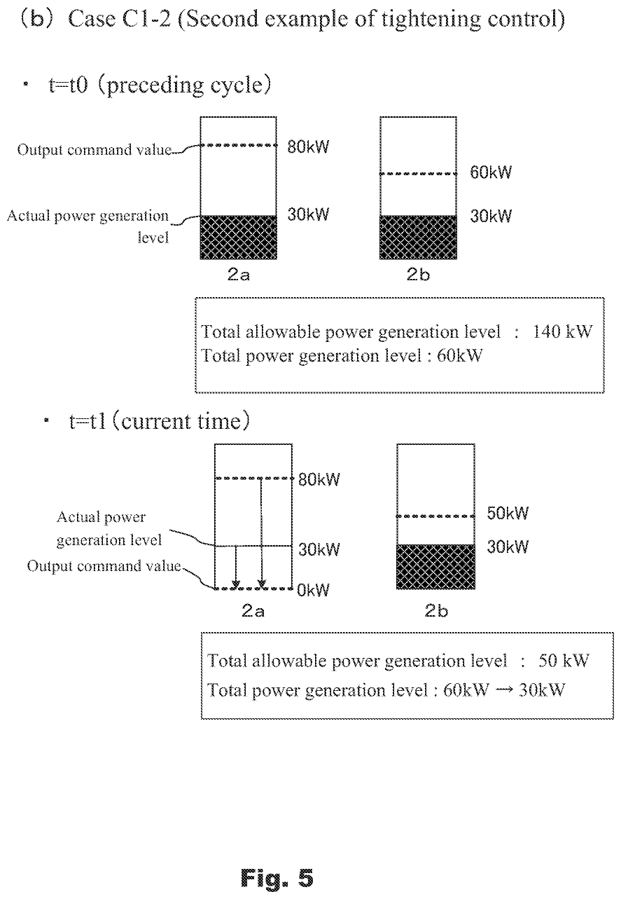

FIGS. 4 and 5 are conceptual diagrams each showing the relationship between the output command value and the actual power generation level for each power generation controller for tightening the control (case a, or C1-1 and case b, or C1-2).

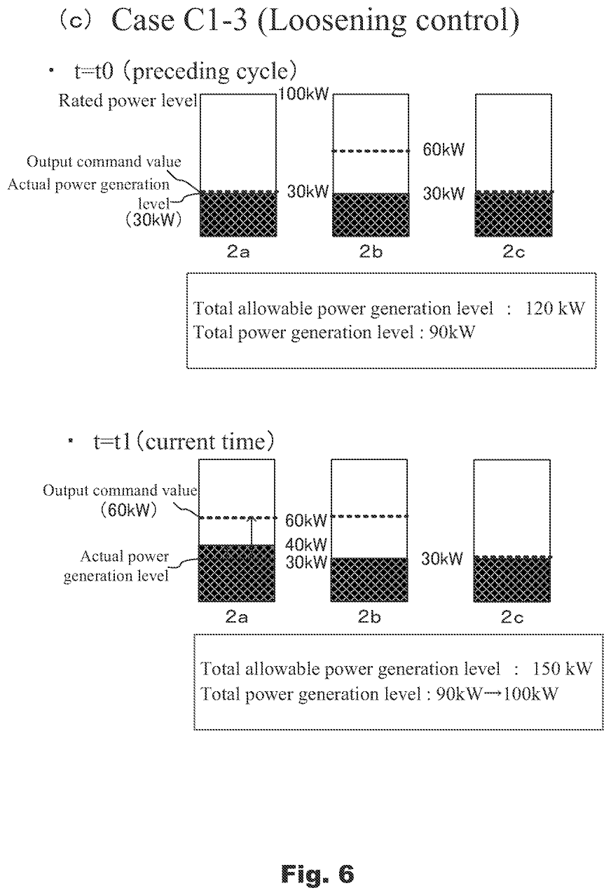

FIG. 6 is a conceptual diagram showing the relationship between the output command value and the actual power generation level for each power generation controller for loosening the control (case c, or C1-3).

In FIGS. 4 to 6, the dotted lines each indicate the output command value set for the power generation controller. The upper end of each hatched area indicates the actual power generation level of the power generation controller.

The command value is transmitted to each power generation controller intermittently. Time t=t0 refers to the time in the preceding cycle, and time t=t1 refers to the current time at which the output command value is recalculated. Time t1 is expressed as t1=t0+Δt, where Δt is a sampling interval in the power generation control system. The sampling interval may be irregular for certain control.

For simplicity of explanation, the control is performed for two power generation controllers 2 (2a and 2b) in case C1-1 (FIG. 4) and case C1-2 (FIG. 5), and for three power generation controllers 2 (2a, 2b, and 2c) in case C1-3 (FIG. 6). The control may be performed in the same manner for more power generation controllers.

Although the initial state of the power generation system 100 (or the start-up of the power generation system 100) is not shown, the initial output command value for each power generation controller 2 may be set by, for example, equally dividing the total allowable power generation level by the number of the power generation controllers, or may be set in another manner. The same applies to the third embodiment described later.

a. Case C1-1 First Example of Tightening Control

In case C1-1 shown in FIG. 4, the output control for each power generation controller is tightened. This control is performed promptly when, for example, the conditions for backfeeding are satisfied with the power generation level exceeding the power consumption level in response to a sudden decrease in the power consumption level.

In an example, at time t in the preceding cycle (t=t0), the power generation controller 2a has an output command value of 80 KW and an actual power generation level of 30 kW, and the power generation controller 2b has an output command value of 60 kW and an actual power generation level of 30 KW. In other words, the total allowable power generation level is 140 KW (80+60 kW), and the total power generation level is 60 kW (30+30 kW) that is the sum of the actual power generation levels.

The total allowable power generation level has decreased to 70 KW at the current time t (t=t1) that is Δt seconds after time t in the preceding cycle (t=t0). The control performed in this case will now be described.

### Operation in C1-1 (FIG. 4)

Time t=t0 (preceding cycle)
Power generation controller 2a: output command value 80 kW and actual power generation level 30 kW
Power generation controller 2b: output command value 60 kW and actual power generation level 30 kW
Time t=t1 (current time)
Power generation controller 2a: output command value 10 kW and actual power generation
level 30→10 KW (expected)
Power generation controller 2b: output command value 60 kW and actual power generation level 30 kW

The control terminal 6 compares the total allowable power generation level at the current time t (t=t1) with the total allowable power generation level at time t in the preceding cycle (t=t0), and determines whether the total allowable power generation level decreases. When the total allowable power generation level decreases, the power generation controller with the maximum actual power generation level at the current time t (t=t1) is selected from the multiple power generation controllers. When more than one power generation controller has the maximum actual power generation level as in case C1-1, at least one power generation controller (e.g., the power generation controller 2a) is selected based on a predefined condition (e.g., in order of the installation number of the power generation controller). In this example, the control terminal 6 selects the power generation controller 2a.

In some embodiments, multiple controllers may be selected as a group. In some embodiments, a power generation controller may be selected repeatedly to determine multiple power generation controllers. For the multiple power generation controllers, a command value may be transmitted collectively.

For the power generation controller 2a, the control terminal 6 decreases (changes) the output command value by a decrease target value with respect to the output command value (80 kW) before the change (specifically, at time t=t0).

The decrease target value is defined as the value resulting from subtracting the total allowable power generation level at the current time t (t=t1) from the total allowable power generation level at time t in the preceding cycle (t=t0).

In case C1-1, the total allowable power generation level at time t=t0 is 140 KW, the total allowable power generation level at time t=t1 is 70 KW, and thus the decrease target value is calculated to be 70 KW. The control terminal 6 subtracts 70 KW from the output command value 80 kW at time t in the preceding cycle (t=t0) for the selected power generation controller 2a, thus yielding 10 KW (=80-70 KW) as an output command value at the current time t (t=t1).

The power generation controller 2a thus has the actual power generation level regulated to 10 KW. At time t in the subsequent cycle (t=t2), the sum of the output command values for the power generation controllers decreases from 140 KW (80+60 kW) to 70 KW (10+60 kW). The total power generation level is expected to decrease from 60 kW (30+30 kW) to 40 KW (10+30 kW).

The output command value after being changed becomes effective to achieve the actual power generation level of 10 KW later than the current time t (t=t1). In other words, the resulting value is the measurement value expected at time t in the subsequent cycle (t=t2) in normal operation. At the time point of its calculation, the determination is not performed as to whether the total power generation level has decreased with the measurement value.

The result of determination in the preceding cycle does not affect the power generation controller selected in the subsequent cycle.

As described above, the total power generation level is controlled to decrease from 60 to 40 kW with the total allowable power generation level being set to 70 kW.

Example control in case C1-1 will now be described with reference to the flowchart in FIG. 3.

### Step Sa1

The control terminal 6 obtains the power consumption level of the loads 5 at time t=t0.

### Step Sa2

The control terminal 6 then calculates the total allowable power generation level at the current time t (t=t1) based on the obtained power consumption level of the loads and the total power generation level at the current time t (t=t1).

### Step Sa3

The determination is performed as to whether the total allowable power generation level at the current time t (t=t1) has decreased from the total allowable power generation level at time t in the preceding cycle (t=t0). For example, the total allowable power generation level is determined to have decreased when the total allowable power generation level at time t=t1 minus the total allowable power generation level at time t=t0 is lower than 0.

### Step Sa3-1-1 for Tightening Control

When the total allowable power generation level is determined to have decreased in step Sa3, the control is determined to be tightened. In this case, the control terminal 6 sets a decrease target value. In case C1-1, the decrease target value is set to 70 kW to respond to a decrease of 70 kW.

### Step Sa3-1-2

The power generation controller with the maximum actual power generation level is then selected. In case C1-1, one of the power generation controllers 2a and 2b, which have the same actual power generation level, is selected based on the predefined condition. In an example, the power generation controller 2a is selected.

### Step Sa3-1-3

For the selected power generation controller 2a, the output command value is decreased by the decrease target value (70 kW) with respect to the output command value (80 kW) at time t=t0. Thus, the control terminal 6 decreases (changes) the output command value at time t=t1 to 10 kW for the selected power generation controller 2a.

### Step Sa3-1-4

The determination is performed as to whether a decrease by the decrease target value 70 KW has been successfully achieved. In case C1-1, a decrease by the decrease target value 70 kW has been successfully achieved in step Sa3-1-3. Thus, the determination as to whether the decrease target value has been achieved is affirmative. The processing then returns to step Sa1.

b. Case C1-2 Second Example of Tightening Control

In case C1-2 shown in FIG. 5, the output control for each power generation controller is tightened, similarly to case C1-1. However, unlike in case C-1, the process is not complete with a single power generation controller to respond to a great decrease in the total allowable power generation level.

In an example, at time t in the preceding cycle (t=t0), the power generation controller 2a has an output command value of 80 kW and an actual power generation level of 30 kW, and the power generation controller 2b has an output command value of 60 kW and an actual power generation level of 30 kW. In other words, the total allowable power generation level is 140 KW (80+60 kW), and the total power generation level is 60 KW (30+30 kW) that is the sum of the actual power generation levels.

The total allowable power generation level has decreased to 50 kW at the current time t (t=t1) that is Δt seconds after time t in the preceding cycle (t=t0). The control performed in this case will now be described.

Operation in C1-2 (FIG. 5)
Time t=t0
Power generation controller 2a: output command value 80 kW and actual power generation level 30 kW
Power generation controller 2b: output command value 60 kW and actual power generation level 30 kW
Time t=t1
Power generation controller 2a: output command value 0 kW and actual power generation level 30→0 kW (expected)
Power generation controller 2b: output command value 50 kW and actual power generation level 30 kW

The control terminal 6 compares the total allowable power generation level at the current time t (t=t1) with the total allowable power generation level at time t in the preceding cycle (t=t0), and determines whether the total allowable power generation level decreases. When the total allowable power generation level decreases, the power generation controller with the maximum actual power generation level at the current time t (t=t1) is selected from the multiple power generation controllers. When more than one power generation controller has the maximum actual power generation level as in case C1-2, at least one power generation controller (e.g., the power generation controller 2a) is selected based on a predefined condition (e.g., in order of the installation number of the power generation controller). In this example, the control terminal 6 selects the power generation controller 2a.

In some embodiments, multiple controllers may be selected collectively. In some embodiments, a power generation controller may be selected repeatedly to determine multiple power generation controllers. For the multiple power generation controllers, a command value may be transmitted collectively.

For the power generation controller 2a, the control terminal 6 decreases (changes) the output command value by the decrease target value with respect to the output command value (80 KW) before the change (specifically, at time t=t0).

The decrease target value is defined as the value resulting from subtracting the total allowable power generation level at the current time t (t=t1) from the total allowable power generation level at time t in the preceding cycle (t=t0).

In case C1-2, the total allowable power generation level at time t=t0 is 140 KW, the total allowable power generation level at time t=t1 is 50 KW, and thus the decrease target value is calculated to be 90 kW. Subtracting 90 kW from the output command value 80 kW at time t in the preceding cycle (t=t0) for the selected power generation controller 2a yields a negative value. The control terminal 6 thus decreases (changes) the output command value for the power generation controller 2a by 80 kW to yield 0 KW (=80-80 KW), instead of subtracting 90 kW from 80 KW, and stores an unachieved value (excess) of 10 kW as a new decrease target value.

The unachieved value (10 kW) is then reflected in the power generation controller 2b with the second lowest actual power generation level. More specifically, unachieved value (10 KW) is subtracted from the output command value (60 kW) at time t in the preceding cycle (t=t0).

The power generation controller 2a thus has the actual power generation level regulated to 0 KW. At time t in the subsequent cycle (t=t2), the sum of the output command values for the power generation controllers decreases from 140 kW (80+60 kW) to 50 KW (0+50 kW). The total power generation level is expected to decrease from 60 kW (30+30 KW) to 30 KW (0+30 kW).

In case C1-2, the decrease target value is not achievable by the first selected power generation controller alone. The output command value for the power generation controller with the second lowest actual power generation level or another power generation controller previously unselected is changed to achieve the unachieved value.

As described above, the total power generation level is expected to decrease from 60 to 30 KW with the total allowable power generation level being set to 50 kW.

The output command value after being changed becomes effective to achieve the actual power generation level of 0 KW later than the current time t (t=t1). In other words, the resulting value is the measurement value expected at time t in the subsequent cycle (t=t2) in normal operation. At the time point of its calculation, the determination is not performed as to whether the total power generation level has decreased with the measurement value.

Example control in case C1-2 will now be described with reference to the flowchart in FIG. 3. Steps Sa1 to Sa3 are the same as in case C1-1, and are not described.

### Step Sa3-1-1 for Tightening Control

In case C1-2, the decrease target value is set to 90 KW (140-50 kW).

### Step Sa3-1-2

The power generation controller with the maximum actual power generation level is then selected. In case C1-2, one of the power generation controllers 2a and 2b, which have the same actual power generation level, is selected based on the predefined condition. In an example, the power generation controller 2a is selected.

### Step Sa3-1-3

For the first selected power generation controller 2a, the output command value is decreased by the decrease target value (80 KW) with respect to the output command value (80 kW) at time t=t0, and the unachieved value (excess) of 10 kW is stored. Thus, the control terminal 6 decreases (changes) the output command value at time t=t1 to 0 KW for the selected power generation controller 2a.

### Step Sa3-1-4

The determination is performed as to whether a decrease by the decrease target value (90 kW) has been successfully achieved. In case C1-2, a decrease by the decrease target value (90 kW) has not been successfully achieved in step Sa3-1-3, with the unachieved value (10 KW) of the target value being left. Thus, the determination as to whether the decrease target value has been achieved is negative. Step Sa3-1-5 is then performed.

### Step Sa3-1-5

In step Sa3-1-5, a power generation controller is selected to reflect the unachieved value of the target value. In this case, the power generation controller with the second highest actual power generation level is basically selected. However, in case C1-2, more than one power generation controller (the power generation controllers 2a and 2b) has the maximum actual power generation level, and the power generation controller 2a is selected in step Sa3-1-2 based on the predefined condition. Thus, the power generation controller 2b, unselected in step Sa3-1-2, is selected in step Sa3-1-5. Step Sa3-1-3 is then performed.

c. Case C1-3 Loosening Control

In case C1-3 shown in FIG. 6, the output control for each power generation controller is loosened. This control is performed when, for example, the power generation level drops below the power consumption level in response to a sudden increase in the power consumption level.

In an example, at time t in the preceding cycle (t=t0), the power generation controller 2a has an output command value of 30 kW and an actual power generation level of 30 kW, the power generation controller 2b has an output command value of 60 kW and an actual power generation level of 30 kW, and the power generation controller 2c has an output command value of 30 kW and an actual power generation level of 30 kW. In other words, the total allowable power generation level is 120 KW (30+60+30 kW), and the total power generation level is 90 KW (30+30+30 kW) that is the sum of the actual power generation levels.

The total allowable power generation level has increased to 150 KW at time t=t1 that is Δt seconds after time t in the preceding cycle (t=t0). The control performed in this case will now be described.

Operation in C1-3 (FIG. 6)
Time t=t0
Power generation controller 2a: rated output 100 kW, output command value 30 kW, and actual power generation level 30 kW
Power generation controller 2b: rated output 100 kW, output command value 60 kW, and actual power generation level 30 kW
Power generation controller 2c: rated output 100 kW, output command value 30 kW, and actual power generation level 30 kW
Time t=t1
Power generation controller 2a: rated output 100 kW, output command value 60 kW, and actual power generation level 30→40 KW (expected)
Power generation controller 2b: rated output 100 KW, output command value 60 kW, and actual power generation level 30 kW
Power generation controller 2c: rated output 100 kW, output command value 30 kW, and actual power generation level 30 kW

The control terminal 6 compares the total allowable power generation level at the current time t (t=t1) with the total allowable power generation level at time t in the preceding cycle (t=t0), and determines whether the total allowable power generation level decreases.

When the total allowable power generation level does not decrease, the power generation controller with the minimum actual power generation level at the current time t (t=t1) is selected from the multiple power generation controllers. When more than one power generation controller has the minimum actual power generation level as in case C1-3, at least one power generation controller (e.g., the power generation controller 2a) is selected based on a predefined condition (e.g., in order of the installation number of the power generation controller). In this example, the control terminal 6 selects the power generation controller 2a.

In some embodiments, multiple controllers may be selected collectively. In some embodiments, a power generation controller may be selected repeatedly to determine multiple power generation controllers. For the multiple power generation controllers, a command value may be transmitted collectively.

For the power generation controller 2a, the control terminal 6 increases (changes) the output command value by a target increase in the output command value (by an increase target value) with respect to the output command value (30 kW) before the change (specifically, at time t=t0).

The increase target value is defined as the value resulting from subtracting the total allowable power generation level at time t in the preceding cycle (t=t0) from the total allowable power generation level at the current time t (t=t1).

In case C1-3, the total allowable power generation level at time t=t1 is 150 KW, the total allowable power generation level at time t=t0 is 120 KW, and thus the increase target value is calculated to be 30 kW. The control terminal 6 adds 30 KW to the output command value 30 kW at time t in the preceding cycle (t=t0) for the selected power generation controller 2a, yielding 60 KW (=30+30 kW) as an output command value at the current time t (t=t1).

The output command value herein refers to the maximum allowable power level, or in other words, the upper limit output of each power generation controller. Under weather conditions that allow sufficient power generation, each power generation controller can output the maximum level of power. Under weather conditions that do not allow sufficient power generation, each power generation controller outputs at most the upper limit of power specified by the output command value.

For solar cells, for example, the power generation controller 2a outputs 40 KW, which is lower than 60 kW specified by the output command value newly set at the current time t=t1, under a certain weather condition such as sunlight being insufficient in cloudy weather or the solar panels being shaded. In this case, the total power generation level is calculated to be 100 KW (40+30+30 KW) as the sum of the power generation levels of the power generation controllers 2a, 2b, and 2c.

The sum of the output command values for the power generation controllers is expected to increase from 120 KW (30+60+30 kW) to, for example, 150 KW (60+60+30 kW). (This is an example and can vary with weather conditions.)

The output command value after being changed becomes effective later than the current time t (t=t1). In other words, the resulting value is the measurement value expected at or after time t in the subsequent cycle (t=t2) in normal operation. At the time point of its calculation, the determination is not performed as to whether the total power generation level has increased with the measurement value. However, the increase in the output command value, or in other words, the upper limit of the power generation level, can cause an increased level of power under appropriate weather conditions.

In case C1-3, the output command value (30 kW) for the first selected power generation controller 2a plus the increase target value (30 kW) is lower than the rated output of 100 kW. The output command value for the power generation controller 2a is thus changed, with no unachieved value being left. Thus, the control terminal 6 ends the change of the output command value. With any unachieved value, the output command value for the power generation controller with the second lowest actual power generation level or another power generation controller previously unselected is changed to achieve the unachieved value.

As described above, the total power generation level is controlled to increase from 90 to 100 KW with the total allowable power generation level being set to 150 kW.

The control in case C1-3 will now be described with reference to the flowchart in

FIG. 3. Steps Sa1 to Sa3 are the same as in case C1-1, and are not described.

### Step Sa3-2-1 for Loosening Control

In case C1-3, the increase target value is set to 30 KW (150-120 KW).

### Step Sa3-2-2

The power generation controller with the minimum actual power generation level is then selected. In case C1-3, one of the power generation controllers 2a, 2b, and 2c, which have the same actual power generation level, is selected based on the predefined condition. In an example, the power generation controller 2a is selected.

### Step Sa3-2-3

For the first selected power generation controller 2a, the output command value is increased by the increase target value (30 kW) with respect to the output command value (30 kW) at time t=10. Thus, the increase target value is set to 30 kW.

### Step Sa3-2-4

The determination is performed as to whether a increase by the increase target value (30 kW) has been successfully achieved. In case C1-3, an increase by the increase target value (30 kW) has been successfully achieved in step Sa3-2-3, with no unachieved value of the target value being left. Thus, the determination as to whether the increase target value has been achieved is affirmative. The processing then returns to step Sa1.

When the determination as to whether the increase target value has been achieved is negative with the increase target value exceeding the rated output by an unachieved value, step Sa3-2-5 is performed to repeat the similar process to achieve the unachieved value.

More power generation controllers may be selected sequentially to reflect the unachieved value of the target value. Step Sa3-2-1 is performed when the total allowable power generation level has not decreased in step Sa3. In other words, step Sa3-2-1 is performed when the total allowable power generation level at time t=t1 has not changed from the total allowable power generation level at time t=t0, in addition to when the power generation level has increased. When the total allowable power generation level has not changed, the increase target value is 0 and the processing returns to step Sa1.

### Second Control Method in Third Embodiment

In the second embodiment described above, a power generation controller as a control target is selected based on a change in the total allowable power generation level, rather than based on the actual power generation level. For the selected power generation controller, a difference in the total allowable power generation level between cycles is reflected as a change in the output command value. Such control, which is not based on the actual power generation level of each power generation controller, can cause the overall power generation to be relatively low, although effectively reducing backfeeding.

With a control method in the third embodiment, the priority of the control target is determined based on the actual power generation level, thus further reducing a decrease in power generation efficiency as compared with the second embodiment. The power generation system 100 has a structure that is the same as in the first embodiment.

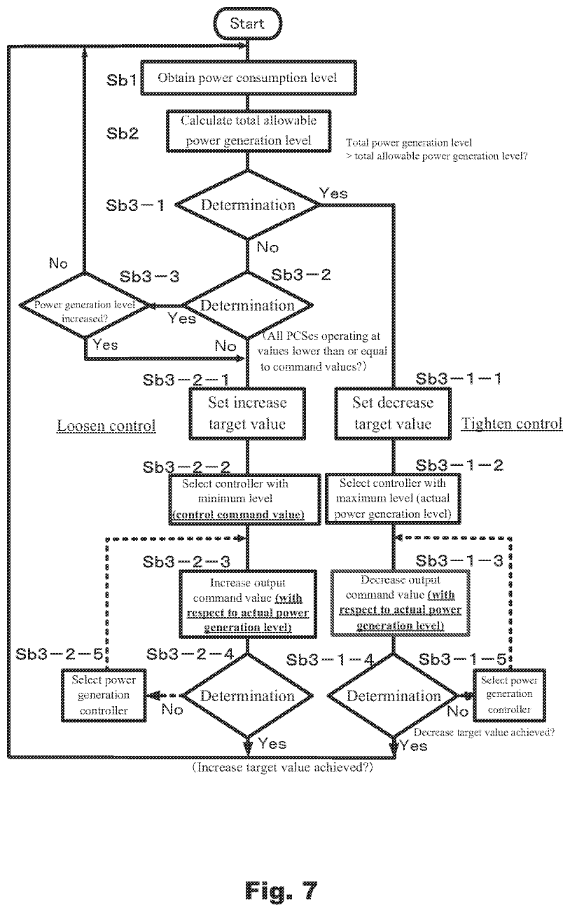

A method for controlling power generation will now be described with reference to FIGS. 7 to 11. FIG. 7 is a main flowchart of a method for controlling power generation according to the third embodiment with the power generation system 100 including the control terminal 6 according to the first embodiment.

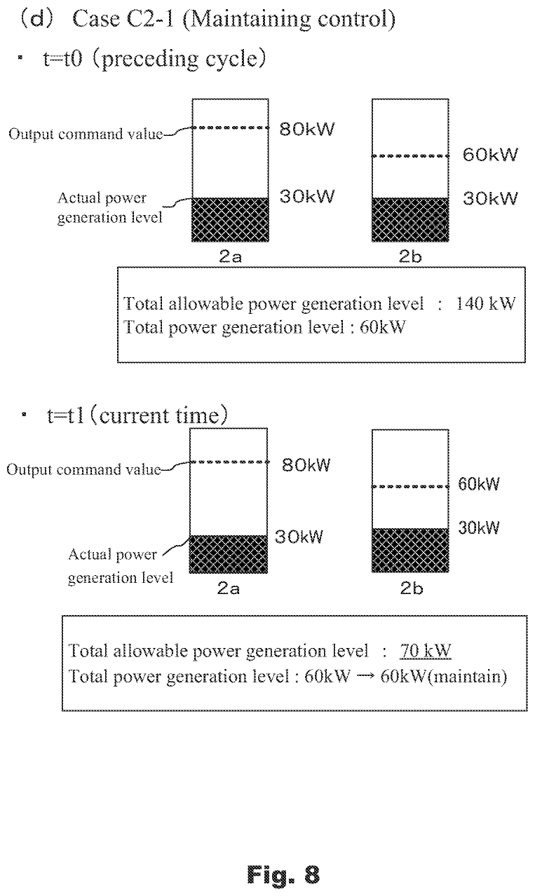

FIG. 8 is a conceptual diagram showing the relationship between the output command value and the actual power generation level for each power generation controller for tightening the control (case d, or C2-1).

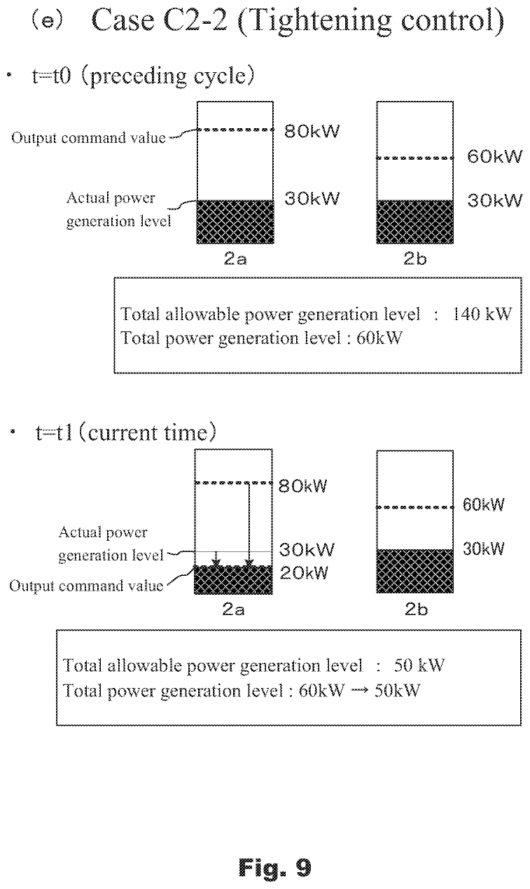

FIG. 9 is a conceptual diagram showing the relationship between the output command value and the actual power generation level for each power generation controller for tightening the control (for decreasing the total allowable power generation level).

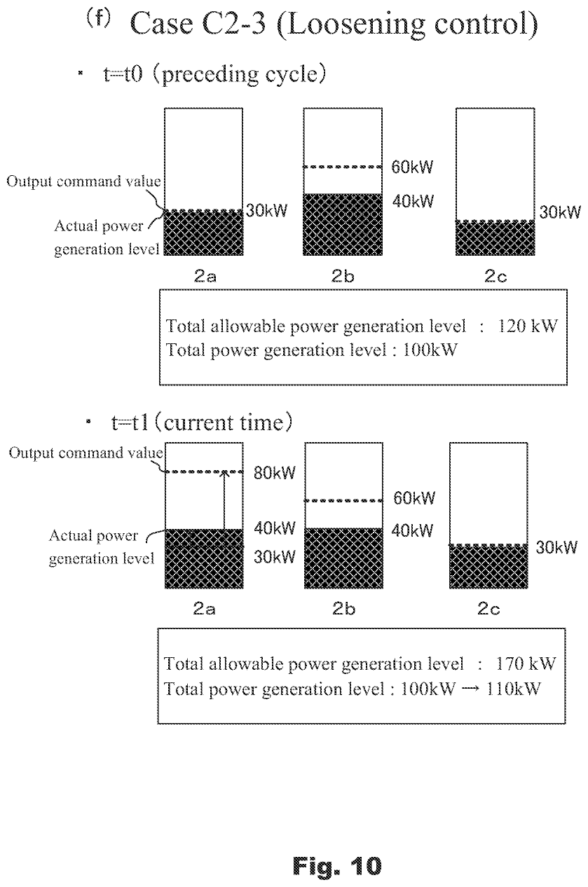

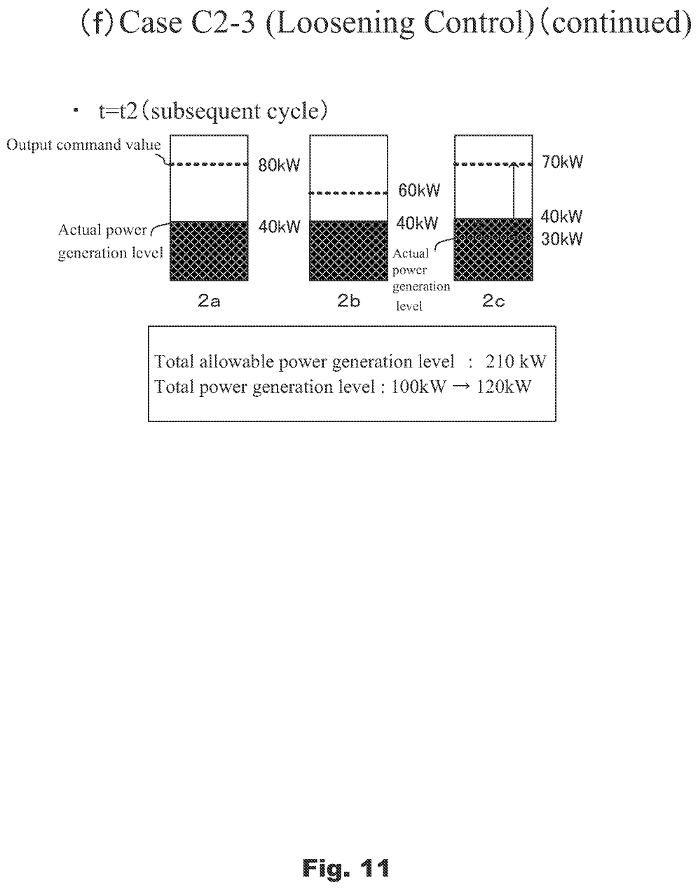

FIGS. 10 and 11 are conceptual diagrams each showing the relationship between the output command value and the actual power generation level for each power generation controller for loosening the control (for increasing the total allowable power generation level).

In FIGS. 7 to 11, the dotted lines each indicate the output command value set for the power generation controller. The upper end of each hatched area indicates the actual power generation level.

FIG. 9 is a conceptual diagram showing the relationship between the output command value and the actual power generation level for each power generation controller for tightening the control (case e, or C2-2).

FIGS. 10 and 11 are each a conceptual diagram showing the relationship between the output command value and the actual power generation level for each power generation controller for loosening the control (case f, or C2-3).

In FIGS. 8 to 11, the dotted lines each indicate the output command value set for the power generation controller. The upper end of each hatched area indicates the actual power generation level.

For simplicity of explanation, the control is performed for two power generation controllers 2 (2a and 2b) in case C2-1 (FIG. 8) and case C2-2 (FIG. 9), and for three power generation controllers 2 (2a, 2b, and 2c) in case C2-3 (FIGS. 10 and 11). The control may be performed in the same manner for more power generation controllers.

Although the initial state of the power generation system 100 (or the start-up of the power generation system 100) is not shown, the initial output command value for each power generation controller 2 may be set by, for example, equally dividing the total allowable power generation level by the number of the power generation controllers, or may be set in another manner. The same applies to the second embodiment described above.

d. Case C2-1 Maintaining Control

FIG. 8 describes an algorithm in case C2-1 for the control at time t in the preceding cycle (t=t0) to be maintained at the current time t (t=t1) to reduce an unintended decrease in the power generation level under conditions with no backfeeding. Case C2-1 will now be described in comparison with case C1-1 in the second embodiment.

In an example, at time t in the preceding cycle (t=t0), the power generation controller 2a has an output command value of 80 kW and an actual power generation level of 30 kW, and the power generation controller 2b has an output command value of 60 kW and an actual power generation level of 30 kW. In other words, the total allowable power generation level is 140 KW (80+60 kW), and the total power generation level is 60 kW (30+30 kW) that is the sum of the actual power generation levels.

The total allowable power generation level has decreased to 70 kW at the current time t (t=t1) that is Δt seconds after time t in the preceding cycle (t=t0). The control performed in this case will now be described.

In other words, the condition at time t in the preceding cycle (t=t0) and the calculation result of the total power generation level at time t=t1 are the same as in case C1-1.

Operation in C2-1 (FIG. 8)
Time t=t0
Power generation controller 2a: output command value 80 kW and actual power generation level 30 kW
Power generation controller 2b: output command value 60 kW and actual power generation level 30 kW
Time t=t1
Power generation controller 2a: output command value 80 kW (unchanged) and actual power generation level 30 KW (maintained)
Power generation controller 2b: output command value 60 kW and actual power generation level 30 KW (maintained)

In the third embodiment, the output command value at time t in the preceding cycle (t=t0) is maintained when the total power generation level satisfies the three conditions below.
I. The total power generation level at the current time t (t=t1) is not higher than the total allowable power generation level at the current time t (t=t1) (step Sb3-1).
II. All the power generation controllers are operating at values lower than or equal to their respective output command values at the current time t (t=t1) (step Sb3-2).
III. The total power generation level at the current time t (t=t1) has not increased from the total power generation level at time t in the preceding cycle (t=t0) (step Sb3-3).

When the above three conditions are satisfied, no power generation controller is expected to increase its power generation level with any increase in the output command value from the output command value at time t in the preceding cycle (t=t0).

In an example, after the control terminal 6 has a total power generation level of 60 kW and a total allowable power generation level of 140 KW at time t in the preceding cycle (t=t0), the total allowable power generation level has changed to 70 KW at the current time t (t=t1).

In this case, the control in the second embodiment (case C1-1) immediately responds to the decrease in the total allowable power generation level, thus decreasing the total power generation level from the level before the control (time t=t0). However, when the total allowable power generation level (70 kW) at the current time t (t=t1) is compared with the total power generation level (60 kW) at the current time t (t=t1), the total power generation level at the current time t (t=t1) is already lower than the total allowable power generation level at the current time t (t=t1) (condition I). Further, the power generation controllers 2a and 2b are both operating at actual power generation levels lower than their output commands (Condition II). Also, the total power generation level at the current time t=t1 (=t0+Δt) has not increased from the total power generation level at time t in the preceding cycle (t=t0) (condition III).

Thus, in case C2-1, the operation is determined to be maintained. Maintaining the control can reduce a decrease in the power generation level.

The control in case C2-1 will now be described with reference to the flowchart in FIG. 7.

### Step Sb1

The control terminal 6 obtains the power consumption level of the loads 5 at time t=t0.

### Step Sb2

The control terminal 6 then calculates the total allowable power generation level in the entire power generation system 100 at the current time t (t=t1) based on the obtained power consumption level of the loads and the total power generation level at the current time t (t=t1).

### Step Sb3-1

The determination is then performed as to whether the total power generation level at the current time t=t1 is higher than the total allowable power generation level at the current time t (t=t1). When the total power generation level at the current time t (t=t1) is higher than the total allowable power generation level at the current time t (t=t1) (the determination result is affirmative), the control is determined to be tightened, thus causing step Sb3-1-1 to be performed. When the total power generation level is not higher (the determination result is negative), the control is determined to be loosened, thus causing step Sb3-2-1 to be performed. When the result is affirmative, or in other words, when the total power generation level at the current time t (t=t1) is higher than the total allowable power generation level at time t=t1, the control is determined to be tightened, thus causing step Sb3-1-1 to be performed.

### Step Sb3-2

In case C2-1, the determination result in Sb3-1 is negative, and step Sb3-2 is performed.

In step Sb3-2, the determination is performed as to whether all the power generation controllers are operating at values lower than or equal to their respective output command values. When the determination result in step Sb3-2 is affirmative, the determination is performed as to whether the total power generation level at the current time t (t=t1) has increased from the total power generation level at time t in the preceding cycle (t=t0) (step Sb3-3). When the total power generation level at time t in the subsequent cycle (t=t2) has not increased, no power generation controller is expected to increase its actual power generation level with any additional increase in the output command value. The processing then returns to step Sb1 (case C2-1).

In this case, the control command value remains unchanged, and the total power generation level is maintained. When the determination result in step Sb3-3 is affirmative, or in other words, when the power generation level has increased, the operation in case f, or C2-3, is performed. The operation will be described in detail later.

e. Case C2-2 Tightening Control

In case C2-2 shown in FIG. 9, the output control for each power generation controller is tightened. This control is performed promptly when, for example, the conditions for backfeeding are satisfied with the power generation level exceeding the power consumption level in response to a sudden decrease in the power consumption level.

In this case, the output control for each power generation controller is tightened, similarly to case C1-2. However, unlike in case C1-2, the calculation is based on the actual power generation level to minimize the decrease in the total power generation level.

In an example, at time t in the preceding cycle (t=t0), the power generation controller 2a has an output command value of 80 kW and an actual power generation level of 30 kW, and the power generation controller 2b has an output command value of 60 kW and an actual power generation level of 30 kW. In other words, the power generation system 100 has a total allowable power generation level of 140 KW (80+60 kW), and a total power generation level of 60 KW (30+30 KW) that is the sum of the actual power generation level.

The total allowable power generation level has decreased to 50 KW at time t (t=t1) that is Δt seconds after time t in the preceding cycle (t=t0). The control performed in this case will now be described.

Operation in C2-2 (FIG. 9)
Time t=t0 (preceding cycle)
Power generation controller 2a: output command value 80 kW and actual power generation level 30 kW
Power generation controller 2b: output command value 60 kW and actual power generation level 30 kW
Time t=t1 (current time)
Power generation controller 2a: output command value 20 kW and actual power generation level 30→20 KW (expected)
Power generation controller 2b: output command value 60 kW and actual power generation level 30 kW

The control terminal 6 compares the total power generation level at the time t (t=t0) in the preceding cycle with the total allowable power generation level at the current time t (t=t1) to determine whether the total power generation level is higher than the total allowable power generation level.

When the total power generation level is determined to be higher than the total allowable power generation level, the control is determined to be tightened. Thus, the power generation controller with the maximum actual power generation level at the current time t (t=t1) is selected from the multiple power generation controllers. When more than one power generation controller has the maximum actual power generation level as in case C2-2, at least one power generation controller (e.g., the power generation controller 2a) is selected based on a predefined condition (e.g., in order of the installation number of the power generation controller). In this example, the control terminal 6 selects the power generation controller 2a. In some embodiments, multiple controllers may be selected collectively. In some embodiments, a power generation controller may be selected repeatedly to determine multiple power generation controllers. For the multiple power generation controllers, a command value may be transmitted collectively.

For the selected power generation controller 2a, the control terminal 6 decreases (changes) the output command value by a decrease target value with respect to the actual power generation level (30 kW) before the change (specifically, at time t=t0).

In case C2-2, the decrease target value is determined by subtracting the total allowable power generation level (50 KW) at the current time t (t=t1) from the total power generation level (60 KW) at the current time t (t=t1), or specifically determined to be 10 kW.

In this case, for the selected power generation controller 2a, the output command value is determined by subtracting the decrease target value (10 KW) from the actual power generation level (30 kW) at the current time t (t=t1), or specifically determined to be 20 kW.

Thus, the power generation controller 2a has the output command value and the actual power generation level each regulated to 20 kW. The total power generation level is thus expected to decrease to a value equal to the total allowable power generation level (50=20+30 KW) at time t in the subsequent cycle (t=t2).

The output command value after being changed becomes effective to achieve the actual power generation level of 20 kW later than the current time t (t=t1). In other words, the resulting value is the measurement value expected at time t in the subsequent cycle (t=t2) in normal operation. At the time point of its calculation, the determination is not performed as to whether the total power generation level has decreased with the measurement value.

As described above, the total power generation level is controlled to decrease from 140 to 50 kW with the total allowable power generation level being set to 50 kW.

The control in case C2-2 will now be described with reference to the flowchart in FIG. 7. Steps Sb1 to Sb3 are the same as in case C2-1, and are not described.

### Step Sb3-1-1 for Decreasing Total Allowable Power Generation Level

In case C2-1, the determination result in step Sb3-1 is affirmative, and Sb3-1-1 is performed. The control terminal 6 sets a decrease target value. In case C2-2, the decrease target value is set to 10 KW (60−50 kW).

### Step Sb3-1-2

The power generation controller with the maximum actual power generation level is then selected. In case C2-2, the power generation controller 2a is selected.

### Step Sb3-1-3

For the selected power generation controller 2a, the actual power generation level is decreased by the decrease target value 10 kW from 30 kW at the current time t (t=t1). With this calculation, the control terminal 6 decreases (changes) the output command value at time t=t1 to 20 kW for the selected power generation controller 2a.

### Step Sb3-1-4

The determination is performed as to whether a decrease by the decrease target value 10 kW has been successfully achieved. In case C1-2, a decrease by the decrease target value 10 kW has been successfully achieved in step Sa3-1-3, with the unachieved value of the target value being 0 kW. Thus, the determination as to whether the decrease target value has been achieved is affirmative. The processing then returns to step Sb3-1.

With any unachieved value of the target value, the power generation controller with the maximum actual power generation level is selected from other power generation controllers previously unselected (step Sb3-1-5). Step Sb3-1-3 for reflecting the unachieved value is then repeated.

f. Case C2-3 Loosening Control

In case C2-3 shown in each of FIGS. 10 and 11, the output control for each power generation controller is loosened. This control is performed when, for example, the power generation level drops below the power consumption level in response to a sudden increase in the power consumption level.

In this case, the output control for each power generation controller is loosened, similarly to case C1-3. However, unlike in case C1-3, the calculation is based on the actual power generation level to maximize the total power generation level.

In an example, at time t in the preceding cycle (t=t0), the power generation controller 2a has an output command value of 30 kW and an actual power generation level of 30 kW, the power generation controller 2b has an output command value of 60 kW and an actual power generation level of 40 kW, and the power generation controller 2c has an output command value of 30 kW and an actual power generation level of 30 kW. In other words, the power generation system 100 has a total allowable power generation level of 120 KW (30+60+30 kW), and a total power generation level of 100 KW (30+40+30 kW) that is the sum of the actual power generation levels.

The total allowable power generation level has increased to 150 KW at time t=t1 that is Δt seconds after time t in the preceding cycle (t=t0). The control performed in this case will now be described.

Operation in C2-3 (FIGS. 10 and 11)
Time t=t0
Power generation controller 2a: output command value 30 kW and actual power generation level 30 kW
Power generation controller 2b: output command value 60 kW and actual power generation level 40 kW
Power generation controller 2c: output command value 30 kW and actual power generation level 30 kW
Time t=t1
Power generation controller 2a: output command value 80 kW and actual power generation level 30-+40 KW (expected)
Power generation controller 2b: output command value 60 kW and actual power generation level 40 kW
Power generation controller 2c: output command value 30 kW and actual power generation level 30 kW
Time t=t2
Power generation controller 2a: output command value 80 kW and actual power generation level 40 kW
Power generation controller 2b: output command value 60 kW and actual power generation level 40 kW
Power generation controller 2c: output command value 70 KW and actual power generation level 30→40 KW (expected)

The control terminal 6 compares the total power generation level at the current time t (t=t1) with the total allowable power generation level at the current time t (t=t1) to determine whether the total power generation level is higher than the total allowable power generation level.

When the total power generation level is determined not to be higher than the total allowable power generation level, the control is not to be tightened. Thus, the power generation controller with the minimum output command value (but not the actual power generation level) at the current time t (t=t1) is selected from the multiple power generation controllers. When more than one power generation controller has the minimum actual power generation level as in case C2-3, at least one power generation controller (e.g., the power generation controller 2a) is selected based on a predefined condition (e.g., in order of the installation number of the power generation controller). In this example, the control terminal 6 selects the power generation controller 2a.

In some embodiments, multiple controllers may be selected collectively. In some embodiments, a power generation controller may be selected repeatedly to determine multiple power generation controllers. For the multiple power generation controllers, a command value may be transmitted collectively.

For the selected power generation controller 2a, the control terminal 6 increases (changes) the output command value by an increase target value with respect to the actual power generation level (30 kW) before the change (specifically, at time t=t0).

The increase target value is determined by subtracting the total power generation level (100 KW) at the current time t (t=t1) from the total allowable power generation level (150 KW) at the current time t (t=t1), or specifically determined to be 50 kW.

In this case, for the selected power generation controller 2a, the output command value is determined by adding the increase target value (50 kW) to the actual power generation level (30 kW) at the current time t (t=t1), or specifically determined to be 80 kW.

Thus, the output command value for the power generation controller 2a at the current time t (t=t1) is set to 80 kW.

However, the output command value newly set for the power generation controller 2a is simply the upper limit, and the actual power generation level may be lower than the new output command value (80 kW). In an example, the power generation controller 2a has an actual power generation level of 40 KW at time t in the subsequent cycle (t=t2). The power generation controller 2c is then selected in step Sb3-2-2 at time t in the subsequent cycle (t=t2). The total actual power generation level of all the power generation controllers (e.g., 40+40+30=110 KW) at the current time t (t=t1) is subtracted from the total allowable power generation level at time t in the subsequent cycle (t=t2) (specifically from 150 KW that is the same as the total allowable power generation level at the current time t (t=t1) when unchanged), yielding 40 kW. The resulting value (40 KW) is added to the actual power generation level at time t (t=t2) (30+40=70 KW) for the selected power generation controller 2c.

The output command value for the power generation controller 2c is increased to 70 KW at time t=t2 (the control is relaxed), allowing the power generation controller 2c to output, for example, 40 kW.

As described above, with the total allowable power generation level being set to 150 kW, the total power generation level is controlled to increase from 100 KW at time t=t0 to 110 W at time t=t1 and to 120 KW at time t=t2. However, the power generation level actually increases or does not increase depending on weather conditions, and the resulting value does not become effective until the subsequent cycle or later.

In this manner, the output command value for each the power generation controller is set higher than the actual power generation level at the current time t (t=t1). Each power generator is thus allowed to further increase its power generation level, and can output power at the maximum level without causing backfeeding.

The control in case C2-3 will now be described with reference to the flowchart in

FIG. 7. Steps Sb1 and Sb2 are the same as in case C2-1, and are not described. In step Sb3-1, the determination is performed as to whether the total power generation level at the current time t (t=t1) is higher than the total allowable power generation level at time t=t1.

### Step Sb3-1

In case C2-3, the total power generation level (100 kW) at the current time t (t=t1) is lower than the total allowable power generation level (150 KW) at the current time t (t=t1). In other words, the determination result in step Sb3-1 is negative, and step Sb3-2 is performed.

### Step Sb3-2

In step Sb3-2, the determination is performed as to whether all the power generation controllers are operating at values lower than or equal to their respective output command values at the current time t (t=t1). In this example, each of the power generation controllers 2a and 2c has the output command value and the actual power generation level being both 30 kW, and can further increase its actual power generation level. Thus, the determination result in step Sb3-2 is negative, and step Sb3-2-1 is performed to loosen the control.

### Step Sb3-2-1

The control terminal 6 sets an increase target value. In case C2-3, the total power generation level at the current time t (t=t1) is 100 KW, the total allowable power generation level at the current time t (t=t1) is 150 KW, and thus the increase target value is set to 50 KW (150-100 kW).

### Step Sb3-2-2

The power generation controller with the minimum output command value is then selected. When more than one power generation controller has the minimum output command value as in case C2-3, at least one power generation controller (e.g., the power generation controller 2a) is selected based on a predefined condition (e.g., in order of the installation number of the power generation controller). In this example, the control terminal 6 selects the power generation controller 2a.

### Step Sb3-2-3

For the selected power generation controller 2a, the actual power generation level is increased by the increase target value 50 kW from 30 kW at the current time t (t=t1). With this calculation, the control terminal 6 increases (changes) the output command value at time t=t1 to 80 kW for the selected power generation controller 2a.

### Step Sb3-2-4

The determination is performed as to whether an increase by the increase target value 50 KW has been successfully achieved. In case C2-3, an increase by the increase target value 50 kW has been successfully achieved in step Sb3-2-3, with the unachieved value of the target value being 0 kW. Thus, the determination as to whether the increase target value has been achieved is affirmative. The processing then returns to step Sb1.

In case C2-3, the actual power generation level of the power generation controller 2a has increased to, for example, 40 kW, at time t in the subsequent cycle (t=t2) as a result of step Sb3-2-3 (FIG. 10).

In this case, the difference between the total allowable power generation level 150 kW and the total power generation level 110 KW is 40 KW at time t in the subsequent cycle (t=t2). Thus, the increase target value is set to 40 kW (150-110 KW) in step Sb3-2-1 after the processing in step Sb1, step Sb2, step Sb3-1 (with the negative determination result), and step Sb3-2 (with the negative determination result). This increase target value is reflected in the power generation controller 2c selected in step Sb3-2-2. The power generation controller 2c thus has the output command value set to 70 KW at time t in the subsequent cycle (t=t2). In case C2-3, at time t in the further subsequent cycle (t=t3), the power generation level of the power generation controller 2c has increased to 40 kW, and the total power generation level has increased to 120 kW.

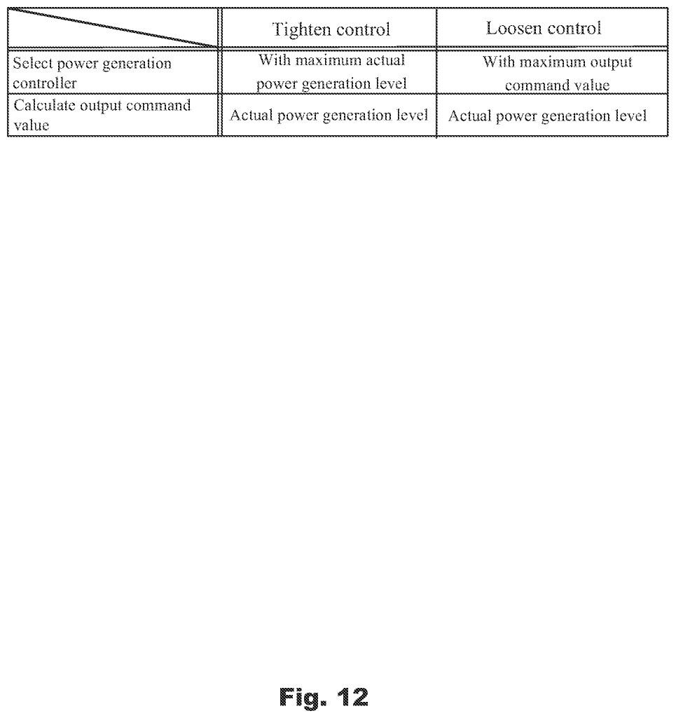

FIG. 12 is a table showing combinations of control patterns to select a power generation controller and to calculate the output command value for tightening and loosening the control in the third embodiment. In the second embodiment and the third embodiment, a power generation controller is selected differently between tightening the control and loosening the control. However, for both tightening the control and loosening the control, the output command value in the subsequent cycle is calculated based on the actual power generation level.

As described above, the distributed power generation system can perform fine power generation control for each of the multiple power generation controllers, thus increasing the power generation efficiency in the entire system and the service life. The algorithm described in each embodiment herein is merely illustrative. Any other algorithm that allows equivalent power generation control falls within the technical scope of the present invention.

### Fourth Embodiment

### Basic Idea

In the first embodiment described above, the power consumption level may be calculated based on the level of the total power generation from the power generation controllers and the level of power supply (grid power) from the utility power system 4 using the power meter installed in the utility power system 4, instead of obtaining the power consumption level of the loads 5 directly from the power meter 9. In this case, each power generation controller (PCS) 2 obtains the total power generation level with a time lag due to the finite response time to the output command value, although each power generation controller 2 receives the grid power level in real time. The time lag can cause a mismatch between the calculated power consumption level and the actual power consumption level. The time lag has a maximum value corresponding to the sampling interval (e.g., six seconds) at which the total power generation level is measured.

Under such circumstances, when the output command value is increased for higher power generation efficiency and the power generation level exceeds the actual power consumption level, the RPR 10 can be activated and stop power generation. Thus, the solar power plant cannot generate power as intended.

The power generation control typically includes two types of control, first control for decreasing the power generation level to avoid backfeeding, and second control for increasing the power generation level of the power generators to reduce power to be purchased from the power company. The first control aims to avoid backfeeding. When the first control is compromised, an emergency device is activated and stops power generation. The second control may be used for more effective control. However, a delay in increase in the power generation level with a time lag is unlikely to cause any notable situation such as a stop of power generation, although such a delay can cause the power generators not to maximize performance. Thus, although the first control is to be prioritized over the second control, the two types of control are used to avoid backfeeding and to increase the power generation level (total power generation level) of the power generators.

In the present embodiment, the three conditions below are used.

### Condition 1

The power generation level used to calculate the power consumption level is updated each time a measurement value is obtained.

### Condition 2

2-1

A change in the grid power level before and after transmission of the output command value is determined to result from the control of each power generation controller. When a change in the grid power level is within a change in the output command value after the output command value is determined previously, the output command value is not recalculated.

When a change in the grid power level is not within a change in the output command value, the output command value is calculated using the current output command value and using the current measurement result based on an excess change in the power consumption level with respect to the change in the output command value at the current time. The change in the grid power level is determined to result from an actual change in the power consumption level.

2-2

The output command value is recalculated independently of the change in the grid power level when the power consumption level further decreases during operation for decreasing the output command value.

### Condition 3

For a power generation controller having a deviation between the output command value and the actual power generation level, an instruction is provided to decrease the output command value to the current power generation level.

Condition 1 allows information about a change in the power generation level to be obtained promptly to approximate the calculation result of the power consumption level (the sum of the grid power level and the power generation level) to the actual power consumption level. Condition 2 allows more accurate calculation of the power consumption level. Condition 3 is set to respond to, for example, a lack of solar radiation or a failure in the power generation facility. In such situations, the outputs of other power generation controllers are increased to generate power at the maximum efficiency. However, the power generation controller having the deviation can increase its output with any later increase in solar radiation. This can cause the power generation level to exceed the allowable power generation level, thus activating the RPR 10 or threshold control. To avoid this, an instruction is provided to the power generation controller having the deviation to decrease the output command value to the current power generation level. In other words, the deviation is corrected, thus avoiding unintended activation of the RPR 10 or the threshold control, although such control of the power generation controllers can occur frequently.

The control terminal 6 calculates the power consumption level based on the actually measured value of grid power and on the total output power level of the power generators obtained from the power generation controllers 2.

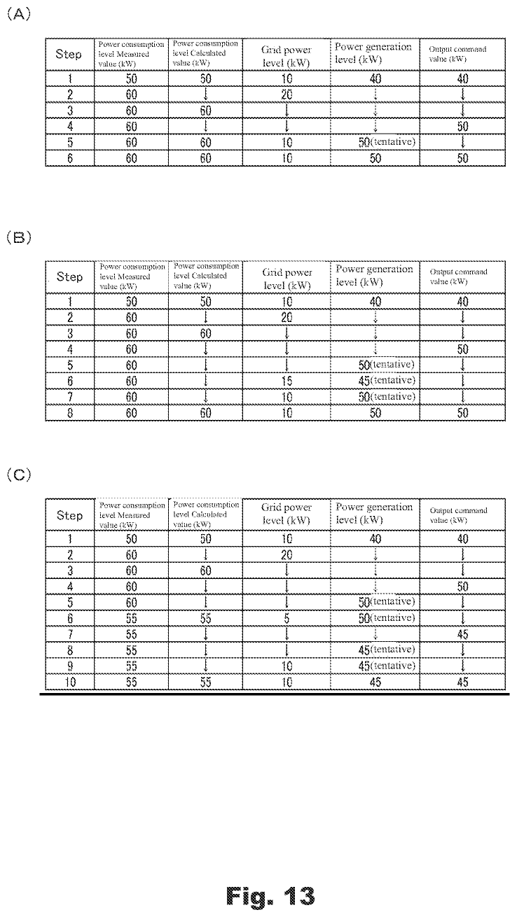

FIGS. 13A to 13C are tables each showing changes in the grid power level, the power generation level, the output command value, and the calculated value of power consumption that is the sum of the grid power level and the power generation level based on conditions 1 to 3. The actually measured values of power consumption shown in the tables in FIGS. 13A to 13C for comparison cannot be used for power generation control.

### Control Pattern 1

FIG. 13A is a table of flowchart showing output command values determined in time series in the present embodiment to describe the control based on condition 1. The down arrows in the table indicate that the numerical values in the preceding steps are maintained.

### Step 1

The control terminal 6 obtains the actually measured value of grid power and the actually measured value of output power from the power generation controller 2. The power consumption level is calculated based on the actually measured value of grid power and the actually measured value of output power from the power generation controller 2.

The control terminal 6 calculates an increase target value or a decrease target value for the output command value based on the calculated power consumption level, and outputs the target value to the power generation controller 2.

At this time point, the actually measured value of grid power is 10 kW, and the actually measured value of output power from the power generation controller 2 is 40 kW. The control terminal 6 calculates the power consumption level to be 50 KW (=10+40 KW) as the sum of these actually measured values. At this time point, the power generation controller 2 has an output command value of, for example, 40 kW (and an actual power generation level lower than or equal to 40 kW).

### Step 2

In an example, the control terminal 6 obtains an actually measured value of grid power of 20 kW from the power meter installed in the utility power system 4. At this time point, the control terminal 6 detects an increase of 10 KW in the grid power level.

### Step 3

The control terminal 6, which has no information about the actual power consumption level, calculates the power consumption level to be 60 KW (=40+20 kW) as the sum of the power generation level (40 kW) and the grid power level (20 kW).

### Step 4

The control terminal 6 calculates the output command value for the power generation controller 2 in the subsequent cycle based on the calculated power consumption level (60 kW). In this case, the control is determined to be loosened to respond to the increased power consumption level. The total allowable power generation level is increased in the manner described in the above embodiments. More specifically, the increase target value is calculated with respect to the output command value for the selected power generation controller 2. In this example, the increase target value (+10 kW) is added to the output command value (40 kW) in the preceding cycle to yield a new output command value 50 kW, which is then transmitted to the power generation controller 2 as an output command value in the subsequent cycle.

### Step 5

Although the grid power level has changed from 20 to 10 from step 4 to step 5, the change is determined to result from the control and the output command value is not recalculated, based on condition 2-1. The power generation level, which is used to calculate the power consumption level, is tentatively determined to be, for example, 50 kW.

### Step 6

When a non-tentative power generation level is obtained from the power generation controller 2, the output command value in the subsequent cycle is recalculated based on the power consumption level 60 kW. In other words, the control terminal 6 in this step obtains the power generation level from the power generation controller 2, determines the power generation level to be 50 kW, recalculates the output command value, and calculates the power consumption level to be 60 KW as the sum of the power generation level 50 kW and the grid power level 10 kW.

As described above, when a change in the grid power level is determined to be within a change in the output command value after the output command value is determined previously, the output command value is not recalculated in the subsequent cycle (condition 2-1). However, when the power consumption level further decreases during operation for decreasing the output command value, the output command value is recalculated independently of the change to tighten the control, thus accommodating a sudden decrease in the power consumption level.

In the example in FIG. 13A, the output power level from the power generation controller 2 matches the output command value in steps 1, 2, 3, and other steps with sufficient sunlight. However, the output power level of the power generation controller 2 may not match but may be lower than the output command value.

### Control Pattern 2

The steps in the example shown in FIG. 13B will now be described in the order of control processing.

Steps 1 to 5 are the same as in the first example and are not described.

### Step 6

In an example, the control terminal 6 detects a change in the actually measured value of grid power from 20 to 15 KW (a decrease of 5 kW) through the power meter installed in the utility power system. With this information alone, the control terminal 6 cannot determine whether the power consumption level has decreased by 5 KW or the power generation level has increased by 5 kW. However, an increase of 5 kW in the power generation level is less than the change (increase) of 10 KW (from 40 to 50 KW) in the output command value, and thus the control terminal 6 can determine that the power generation level has not reached 50 kW indicated as the output command value. Thus, the output command value in the preceding cycle is maintained in the subsequent cycle without being recalculated. With an increase of 5 kW in the power generation level, the power generation level deviates from the command value 50 kW by −5 kW. Thus, the tentative power generation level is set to 45 kW.

### Step 7

In an example, the control terminal 6 detects a change in the actually measured value of grid power from 15 to 10 KW (a further decrease of 5 kW) through the power meter installed in the utility power system. This indicates that the grid power level has decreased by 10 kW in total from the time point of step 2. The power generation level is maintained to be tentative without being fixed until measurement is performed. The current power generation level is still determined to result from the control, and the output command value is thus not recalculated based on condition 2-1. The same processing as in the preceding step (step 6) is performed.

### Step 8

Similarly to step 6 in control pattern 1, the measured power generation level is 50 kW, and the power consumption level is calculated to be 60 kW.

### Control Pattern 3

The steps in the example shown in FIG. 13C will now be described in the order of control processing.

Steps 1 to 5 are the same as in the first example and are not described.

### Step 6

The control terminal 6 detects a change in the actually measured value of grid power from 20 to 5 KW (specifically, a decrease of 15 kW). With this information alone, the control terminal 6 cannot determine whether the power consumption level has decreased by 15 kW or the power generation level has increased by 15 kW. However, the power generation level cannot have increased by 15 KW (the increase can be 10 kW at most) when the decrease (15 kW) in grid power is greater than the increase (10 KW) from the power generation level in step 4 to the provisional power generation level 50 kW in step 5. Thus, the control terminal 6 determines that the power generation level has increased by 10 kW (reached the provisional power generation level 50 kW) and that the power consumption level has decreased by 5 kW. The power consumption level can further continue to decrease to below the current level, possibly causing backfeeding. Thus, the output command value is recalculated in the subsequent step included in the current cycle (condition 2-2).

### Step 7

The output command value is recalculated and set to 45 kW. With the decrease of 5 KW in the power consumption level in step 6, the output command value decreased to 45 kW is transmitted while the provisional power generation level remains unchanged at 50 kW.

### Step 8

The power generation level is changed to 45 kW as the provisional power generation level in response to the output command value transmitted in step 7. The provisional power generation level determined in this step is not an actually measured value but is used simply to calculate the power consumption level.

### Step 9

The control terminal 6 detects a change in the actually measured value of grid power from 5 to 10 KW (specifically, an increase of 5 kW). The change is within the decrease 5 kW (from 50 to 45 kW) in the power generation level (provisional power generation level) from step 7 to step 8. However, the power generation level, which has not been measured, is maintained to be tentative without being fixed at this time point. In other words, the output command value is not recalculated based on condition 2-1, and the same processing as in the preceding step (step 8) is performed.

### Step 10

Similarly to in step 8 in control patterns 1 and 2, the control terminal 6 obtains the power generation level through the power generation controller 2, determines that the power generation level has not changed from 45 kW determined in step 9, and calculates the power consumption level to be 55 KW as the sum of the power generation level 45 kW and the grid power level 10 kW.

### Overview

As described above, the actually measured value of output power from the power generation controller 2 is transmitted to the control terminal 6 at predetermined intervals, or specifically, sampling intervals. During the sampling interval, the control terminal 6 calculates the output command value using the actually measured value of grid power and outputs the calculated value to the power generation controller 2 to manage the power generation level in the processing described above.

### Example Use

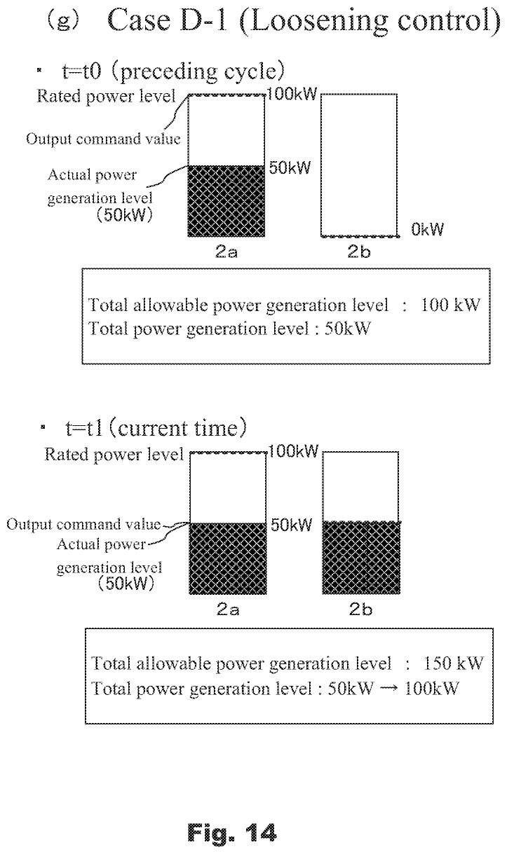

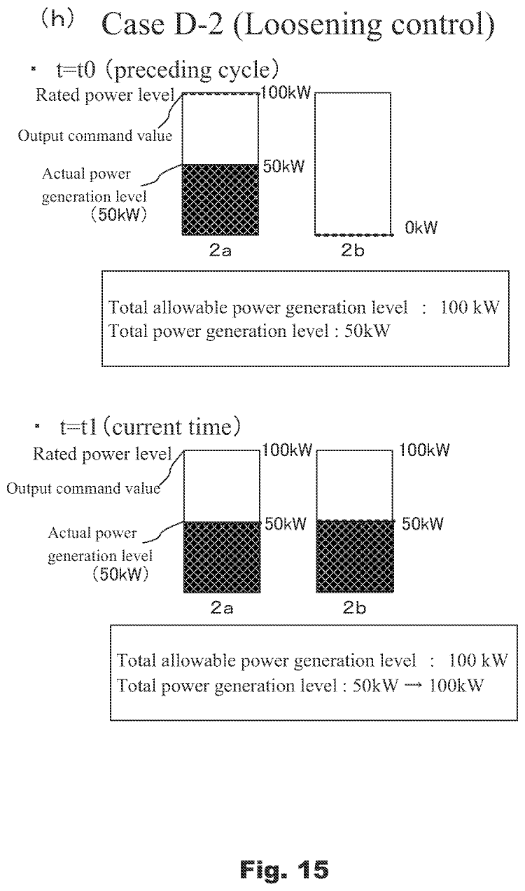

An example use of the algorithm in the present embodiment will now be described using a working example below. A comparative example (without using conditions 1 to 3) is described first with reference to FIG. 14, and then the working example (using conditions 1 to 3) is described with reference to FIG. 15.

### COMPARATIVE EXAMPLE

For the two power generation controllers 2 (2a and 2b) both with a rated capacity of 100 KW, an output command value of 100% is transmitted to the power generation controller 2a at a time point (t=t0 in the preceding cycle), and an output command value of 0% is transmitted to the power generation controller 2b at the time point (t=t0 in the preceding cycle). When the power generation controller 2a has a power generation level of 50 kW and the power generation controller 2b has a power generation level of 0 kW, the control in the subsequent cycle (t=t1) transmits, to the power generation controller 2b, an output command value of 50% without transmitting another output command value to the power generation controller 2a. The output command value of 50% for the power generation controller 2b corresponds to 50 kW (=100-50 kW) by which the power generation level deviates from the output command value for the power generation controller 2a.

### Working Example

For the two power generation controllers 2 (2a and 2b) both with a rated capacity of 100 KW, an output command value of 100% is transmitted to the power generation controller 2a at a time point (t=t0 in the preceding cycle), and an output command value of 0% is transmitted to the power generation controller 2b at the time point (t=t0 in the preceding cycle). When the power generation controller 2a has a power generation level of 50 kW and the power generation controller 2b has a power generation level of 0 kW, the control in the subsequent cycle (t=t1) transmits an output command value of 50% to the power generation controller 2a again, and then transmits, to the power generation controller 2b, an output command value of 50% corresponding to 50 kW by which the power generation level deviates from the output command value for the power generation controller 2a.

In this manner, the output command value is set timely and appropriately without shifting to the subsequent cycle with an uncorrected deviation of the actual power generation level from the output command value. This avoids unintended activation of the RPR 10 or the threshold control, although the power generation controllers are to be controlled more frequently as described above.

### INDUSTRIAL APPLICABILITY

The power generation system according to one or more embodiments of the present invention may be used in a power generation facility including multiple power generators and multiple power generation controllers to control the outputs of the respective power generators. In the facility, the system can respond to the changeable power consumption level of loads and avoid backfeeding, thus increasing the use efficiency of the power generators that are susceptible to external environment. The system has high industrial applicability in such a facility.

### REFERENCE SIGNS LIST

1 (1a, 1b, . . . , 1n) power generator
2 (2a, 2b, . . . , 2n) power generation controller
4 utility power system
5, 5a, 5b, . . . , 5m load
6 power generation controller (control terminal)
61 measurement input-output unit
62 processor (arithmetic processor)
63 storage
64 control input-output unit
9 power meter
10 reverse power relay (RPR)
100 power generation system
s (s2, s9) signal line
L2, Lb2a, Lb2b, Lb2n power line
L4 power line
L5 power line

1. A program for a control terminal to control output power of a power generation system, the power generation system including a plurality of power generators and a plurality of power generation controllers to control output power generation levels of the plurality of power generators, the program being executable to perform operations comprising:
obtaining a power consumption level of a load;
obtaining a total allowable power generation level of the power generation system;
determining whether the total allowable power generation level of the power generation system decreases or increases with respect to the total allowable power generation level at a time (t=t0) in a preceding cycle by calculating the total allowable power generation level based on the power consumption level and a total power generation level of the plurality of power generators;
calculating, based on a result of the determining, an output command value at a current time (t=t1) for each of the plurality of power generation controllers.

2. The program according to claim 1, wherein
the determining includes determining whether the total allowable power generation level decreases, and when determining that the total allowable power generation level decreases, the determining at least includes
calculating a decrease target value,
selecting, from the plurality of power generation controllers, a power generation controller having a maximum actual power generation level,
reflecting the decrease target value with respect to the output command value for the selected power generation controller, and
determining whether the decrease target value is achieved.

3. The program according to claim 2, wherein
the determining includes, when the decrease target value is unachieved, selecting, from the plurality of power generation controllers, a power generation controller previously unselected and having a maximum actual power generation level, and performing the reflecting again to reflect an unachieved value of the decrease target value for the selected power generation controller.

4. The program according to claim 1, wherein
the determining includes determining whether the total allowable power generation level decreases, and when determining that the total allowable power generation level does not decrease, the determining at least includes
calculating an increase target value,
selecting, from the plurality of power generation controllers, a power generation controller having a minimum actual power generation level,
reflecting the increase target value with respect to the output command value for the selected power generation controller, and
determining whether the increase target value is achieved.

5. The program according to claim 4, wherein
the determining includes, when the increase target value is unachieved, selecting, from the plurality of power generation controllers, a power generation controller previously unselected and having a minimum actual power generation level, and performing the reflecting again to reflect an unachieved value of the increase target value for the selected power generation controller.

6. The program according to claim 1, wherein
the determining includes determining whether the total power generation level at the current time (t=t1) is higher than the total allowable power generation level at the current time (t=t1), and when determining that the total power generation level is higher than the total allowable power generation level, the determining at least includes
calculating a decrease target value,
selecting, from the plurality of power generation controllers, a power generation controller having a maximum actual power generation level,
reflecting the decrease target value with respect to an actual power generation level for the selected power generation controller, and
determining whether the decrease target value is achieved.

7. The program according to claim 6, wherein
the determining includes, when the decrease target value is unachieved, selecting, from the plurality of power generation controllers, a power generation controller previously unselected and having a maximum actual power generation level, and performing the reflecting again to reflect an unachieved value of the decrease target value for the selected power generation controller.

8. The program according to claim 6, wherein
the determining includes determining whether the total power generation level at the current time (t=t1) is higher than the total allowable power generation level at the current time (t=t1), and when determining that the total power generation level is not higher than the total allowable power generation level, the determining at least includes
determining whether all the plurality of power generation controllers are operating at values lower than or equal to the output command values, and
when determining that all the plurality of power generation controllers are operating at values lower than or equal to the output command values, determining whether a power generation level at the current time (t=t1) has increased from a power generation level at a time (t=t0) in a preceding cycle, and
when determining that all the plurality of power generation controllers are operating at values lower than or equal to the output command values and the power generation level at the current time (t=t1) has not increased from the power generation level at the time (t=t0) in the preceding cycle, maintaining an output level at the time (t=t0) in the preceding cycle and returning to the obtaining the power consumption level.

9. The program according to claim 1, wherein
the determining includes determining whether the total power generation level at the current time (t=t1) is higher than the total allowable power generation level at the current time (t=t1), and when determining that the total power generation level is not higher than the total allowable power generation level, the determining at least includes
determining whether all the plurality of power generation controllers are operating at values lower than or equal to the output command values, and
when determining that all the plurality of power generation controllers are operating at values lower than or equal to the output command values, determining whether a power generation level at the current time (t=t1) has increased from a power generation level at a time (t=t0) in a preceding cycle, and
when determining that not all the plurality of power generation controllers are operating at values lower than or equal to the output command values or when determining that the power generation level at the current time (t=t1) has increased in the determining,
calculating an increase target value, selecting, from the plurality of power generation controllers, a power generation controller having a minimum output command value,
reflecting the increase target value with respect to an actual power generation level for the selected power generation controller, and
determining whether the increase target value is achieved.

10. The program according to claim 9, wherein
the determining includes, when the increase target value is unachieved, selecting, from the plurality of power generation controllers, a power generation controller previously unselected and having a minimum output command value, and performing the reflecting again to reflect an unachieved value of the increase target value for the selected power generation controller.

11. The program according to claim 1, wherein
the obtaining the power consumption level of the load includes calculating the power consumption level being a sum of a grid power level and the output power generation level based on condition (1), condition (2-1), condition (2-2), and condition (3):
(1) a power generation level used to calculate the power consumption level is updated each time a measurement value is obtained,
(2-1) when a change in the grid power level is within a change in the output command value after the output command value is determined previously, the output command value is not recalculated, with the change in the grid power level before and after transmission of the output command value being determined to result from the control of each of the plurality of power generation controllers, and when the change in the grid power level is not within the change in the output command value, the output command value is calculated using a current output command value and using a current measurement result based on an excess change in the power consumption level with respect to the change in the output command value at a current time, with the change in the grid power level being determined to result from an actual change in the power consumption level,
(2-2) the output command value is recalculated independently of the change in the grid power level when the power consumption level further decreases during operation for decreasing the output command value, and
(3) for a power generation controller of the plurality of power generation controllers having a deviation between the output command value and an actual power generation level, an instruction is provided to decrease the output command value to a current power generation level.

12. A control terminal to execute the program according to claim 1.

13. A method for manufacturing a power generation system, the method comprising:
connecting the control terminal according to claim 12 to a power generation controller configured to control an output based on an output command value.
